(19) United States
(12) Patent Application Publication
(10) Pub. No.: US 2006/0209533 A1
(43) Pub. Date: Sep. 21, 2006

(54) Elastic flashlight fastner

(76) Inventor: Bryan Howard Druzin, Toronto (CA)

Correspondence Address: BRYAN H. DRUZIN, 120 KIRK DR., THORNHILL, L3T 3L4, CA

(21) Appl. No.: 11/084,620

(22) Filed: Mar. 21, 2005

(51) Int. Cl. F21V 21/108

(52) U.S. Cl. 362/108

(57) ABSTRACT

A device for fastening a flashlight (22), in multiple of ways, to a wide range of objects of considerably diverse shapes and sizes including many different parts of the human body so as to allow a person to use a flashlight (22) while maintaining free use of both his or her hands. The device may be conveniently and swiftly secured to an object without the need to further adjust the device so as to make it conform to the specific dimensions of the object.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to flashlights, specifically to a device for fastening a flashlight to objects of various shapes and sizes including many different parts of the human body.

2. Prior Art

It has long been a problem to use a flashlight to provide light to a specific area without forcing the user of the flashlight to use at least one hand to hold the flashlight. The need often arises while pitching a tent, hiking, hunting, cycling, working, writing and reading in darkened locations, as well as performing other activities in a wide variety of situations. Typically, when in this situation, the user will balance the flashlight on a nearby object, lie it on the ground, or even place the butt portion of the flashlight into their mouth so as to direct the beam of light onto the desired spot. These are inadequate and often uncomfortable solutions. Thus it is desirable to provide some means whereby a flashlight may be used while maintaining both hands free.

Recognizing this need, numerous devices have been designed. A number of these devices are designed to allow the flashlight to be held to the user's head or wrist in some manner or another. For example, U.S. Pat. No. 2,263,577 to Griner (1939) discloses a flashlight comprising a strap adapted to be placed around the head of the user; however it suffers from the disadvantage that the flashlight to which the headband is attached must be of a particular construction in order to accommodate the headband. U.S. Pat. No. 4,718,126 to Slay (1988) discloses a headband comprising a pocket that a flashlight may be inserted into; however it suffers from the disadvantage of being designed for use only on the user's head. Moreover, it cannot be stored conveniently on the body of the flashlight. U.S. Pat. No. 4,360,930 to Blanchard (1982) shows a device with a flexible headband that may be wrapped around the body of the flashlight. Although this has the advantage of being stored on the body of the flashlight, it is not designed to accommodate a wide range of differently shaped objects apart from the head. As well, it requires the user to adjust the strap so as to secure it snugly to the head. U.S. Pat. No. 5,154,506 to Leard (1992) discloses a flashlight armband. This has the disadvantage of not being easily adaptable to other parts of the body. As well, the device is not designed to allow a flashlight to be secured to other types of objects. U.S. Pat. No. 6,315,426 to Buller (2001) discloses a device that allows a flashlight to be mounted to the user's shoulder; however it suffers from the disadvantages of being relatively large, cumbersome, complex and designed to secure a flashlight to only the user's shoulder. The device cannot be used on other parts of the body nor other objects. U.S. Pat. No. 6,851,214 to Oz (2005) discloses a mounting system for a flashlight to the barrel of a rifle. This device is limited to securing a flashlight to a firearm.

The need to secure a flashlight to some object or another so as to allow the user to maintain free use of his or her hands has long been recognized. Consequently a great number of devices have been designed to address this need. However, although the prior technology does much to address the problem of fastening a flashlight to some object or another so that a person has his or her hands free, there are a number of deficiencies in all of the designs:

(a) The most significant limitation of the prior art is that these devices are designed to fasten the flashlight to the head or other specific object. None of these devices are versatile enough to allow the flashlight to also be fastened to many other parts of the human body, as well as to a wide range of other objects of different shapes and sizes other than the user's body. Furthermore, these devices do not allow a flashlight to be secured to an object in a variety of manners allowing the user to employ the most appropriate method. All these devices, therefore, lack a universal character in terms of their potential application.

(b) Another limitation to the prior art is that the need to use a flashlight while maintaining free use of both hands often arises in situations where it is unexpected. Generally, these devices require the user to anticipate the situation in advance and thus have the device on hand at all times. This is often not practical. Additionally, even when the situation is anticipated, the need often arises too infrequently to warrant bringing the device and having it with the user at all times. Further, if the user is engaging in an activity where the need to use a flashlight while maintaining free use of both hands is a constant need, it is likely the person will simply use a relatively more expensive headlamp-type flashlight designed especially for such situations.

(c) Moreover, often a flashlight is used as a light source for more than one person. In this situation, if the flashlight is secured to the body of one of the persons, when that person shifts position, for example turning their head, the beam of light will accordingly turn making it difficult for the other person(s) to see clearly.

(d) As well, many of these devices are designed to be used with a very specific kind of flashlight or even require the device to be sold with a particular flashlight. This consequently places a tremendous limitation on the potential use of the device.

(e) Generally, devices that are designed to be stored on the body of the flashlight itself provide no additional function and often result in making the flashlight more cumbersome and awkward to use when the device is not being employed. As well, if the device is stored in this fashion, it is often uneasy to detach and reattach the device to the flashlight in a convenient manner.

(f) Moreover, these devices do not allow a flashlight to be conveniently and swiftly fastened to an object. The devices often require the user to make some kind of involved adjustment such as shortening or lengthening a strap in order to fasten the flashlight in a secured fashion.

(g) Generally, it is believed such devices suffer from a lack of simplicity in design and an unnecessary amount of components. Consequently, the devices are unnecessarily complex and relatively costly to manufacture.

Accordingly there exists a need to provide a way to quickly and conveniently fasten a flashlight to a wide range of objects of many different sizes and shapes as well as the many different parts of the user's body. Ideally, if fastened to the human body, the device would allow the user to secure the flashlight to more than just one part of the body such as the head or arm. The device should be small, lightweight and adaptable to a variety of flashlight designs. The device should permit the flashlight to be fastened in multiple ways so as to best conform to the object and without the need for further adjustment after it is secured. Moreover, the device should be able to be manufactured cheaply and stored in a non-cumbersome, simultaneously useful fashion on the body of the flashlight.

### OBJECTS AND ADVANTAGES

Accordingly:

(a) it is the primary object of the present invention to provide a means for fastening a flashlight to a wide range of objects of significantly different shapes and sizes including many different parts of the human body such as, the top of the hand, the wrist, the forearm, the shoulder, the head, the waist, and the upper leg, thereby allowing a person to use the flashlight while maintaining free use of his or her hands. It is an object of the present invention to provide a device that will allow the flashlight to be secured to many different objects and is not restricted to being used in conjunction with one specific object. The device will be versatile enough to allow a flashlight to be secured to a wide variety of dissimilarly shaped objects such as: tree trunks, tree branches, backpacks, rifles, over-hanging beams, parts of furniture, bed posts, appliances, poles, beams, parts of cars, parts of boats, parts of motorcycles, parts of other vehicles, parts of a tent, bicycle handle bars, wheelchairs, different kinds of helmets and hats, glasses, goggles, canes, the handle of fishing nets, fishing rods, various power tools, handguns and animal leashes. In addition, the device will often allow a user to secure a flashlight to an object in a variety of manners, thus allowing the user to employ the most appropriate method;

(b) another object of the invention is to provide a fastening device for a flashlight that may be conveniently stored in a non-cumbersome fashion on the flashlight so as to be readily available for use if a situation arises where it becomes suddenly necessary to fasten the flashlight to some object or another. Thus, the need to fasten the flashlight need not be anticipated in advance;

(c) it is another object of the invention to provide a device and method, which will allow a person to fasten a flashlight to an object, such as an overhanging beam or tree branch, thereby allowing the flashlight to be used as an overhead-light source for one or more persons;

(d) a further object of the invention is to provide a fastening device for a flashlight that can be used in conjunction with a wide range of flashlight designs. Therefore, the device may be sold separately as a flashlight accessory.

(e) Another object of the invention is to provide a fastening device for a flashlight that may be stored on the flashlight in a non-cumbersome manner when not being used. Further, the device may be detached and reattached to the flashlight in a convenient manner;

(f) still another object of the present invention is to provide a fastening device for a flashlight that may be conveniently and swiftly secured to an object that will conform to the general shape of the object without the need to further adjust the device so as to make it accommodate the object's specific dimensions;

(g) yet another object of the present invention is to provide a fastening device for a flashlight which is extremely simple in design comprising a minimal amount of components, thus allowing the device to be used in an uncomplicated manner and manufactured relatively cheaply.

Further objects and advantages are, the device will enable a conventional flashlight to be readily converted into a headlamp-type light. If the flashlight is fastened around the user's head, the vertical orientation at which the beam of light is directed may be adjusted to a plurality of angles if desired. Moreover, the device will also allow most flashlights to be secured to the handlebars of a bicycle thereby allowing most flashlights to be used as a cycle light. Additionally, the device can serve as a handle for the flashlight. The device may also serve as a hand strap. Further, the device may serve as a conventional lanyard strap. The device will enable the flashlight to be hung on a hook, etc. The device can also be attached to a flashlight together with a conventional lanyard. Additionally, if the need should arise, the device can be removed from the flashlight and used separately as an elastic binding cord. Furthermore, the device may be stored by being wound around the body of the flashlight thus simultaneously serving as a retention grip for the user's hand. Further objects and advantages of my invention will become apparent from a consideration of the ensuing drawings and description.

### SUMMARY

The present invention provides a means for fastening a flashlight to a wide range of objects of considerably different shapes and sizes, including the different parts of the human body, so as to allow a person to use the flashlight while maintaining free use of both his or her hands.

### DRAWINGS—FIGURES

The drawings furnished herewith illustrate a preferred construction of the present invention in which the above advantages and features are clearly disclosed as well as others which will readily be understood from the following description. In the drawings:

FIG. 1 shows a flashlight fastener of the present invention.

FIG. 2 shows the looped end of the elongated elastic element to which the attachment ring loop is attached.

FIG. 3 shows the flashlight fastener attached to the flashlight's butt portion.

FIG. 4 shows the annular ring-shaped first end portion of the flashlight fastener being stretched over the head portion of the flashlight.

FIG. 5 shows the flashlight fastener attached to two portions of the flashlight, the annular ring-shaped first end portion of the flashlight fastener having been placed about the body of the flashlight.

FIG. 6 shows the flashlight secured to the user's head by the flashlight fastener.

FIG. 7 shows the flashlight secured to the user's head by the flashlight fastener so as to adjust the vertical orientation at which the flashlight's beam of light is directed.

FIG. 8 shows the device fastened to the user's outer left forearm in a wrap-around fashion.

FIG. 9 shows the flashlight secured to the user's inner left wrist, the elastic element binding the body of the flashlight in a crisscross fashion.

FIG. 10 shows the user with the flashlight fastener fastened around his waist thereby securing the flashlight above the user's left hip.

FIG. 11 shows the user with the flashlight fastened to the top of the user's left shoulder, the flashlight fastener strapped beneath the user's left armpit.

FIG. 12 shows the user with the flashlight fastened to the top of the user's right shoulder, the flashlight fastener strapped across his chest and back and held beneath the user's left armpit.

FIG. 13 shows the user with the flashlight fastener fastened around the user's upper right leg thereby securing the flashlight thereon.

FIG. 14 shows the user with the flashlight fastener fastened around the user's right arm thereby securing the flashlight thereon.

FIG. 15 shows the flashlight fastener, having been partially wrapped around the flashlight's body forming a tighter cincture, being stretched open by the user so as to be placed around an object.

FIG. 16 shows the flashlight fastener secured to the flashlight at two ends being used as a handle with which to hold the flashlight.

FIG. 17 shows the flashlight fastener wrapped around the body portion of the flashlight to store the device, and at the same time, allow the device to be used as a handgrip.

FIG. 18 shows the flashlight fastener wrapped around the flashlight's butt portion so as tore the device in a non-cumbersome, unobtrusive manner.

FIG. 19 shows an alternative embodiment of the attachment connector.

FIG. 20 shows the same alternative embodiment of the attachment connector.

FIG. 21 shows another alternative embodiment of the attachment connector in which the attachment ring loop is embedded in a portion of one end of the elongated elastic element.

### DRAWINGS—REFERENCE NUMERALS

20 flashlight fastener
22 flashlight
24 Attachment ring loop
26 attachment connector
26a lanyard hole attachment ring
26b clamp
28 elongated elastic element
30 annular ring-shaped first end
32 flashlight's body portion
34 lanyard hole
36 flashlight's head portion
38 flashlight's butt portion
40 user's head
42 left wrist
44 left forearm
46 right hand

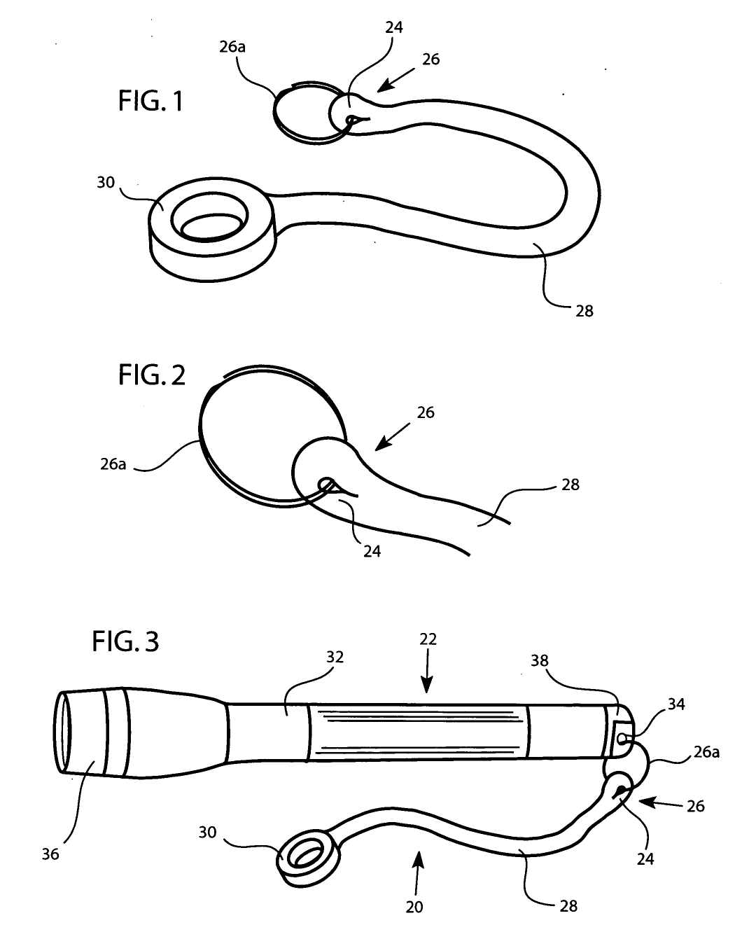

### DETAILED DESCRIPTION—FIGS. 1, 2, 3—PREFERRED EMBODIMENT

A preferred embodiment of flashlight fastener 20 of the present invention is illustrated in FIG. 1. Flashlight fastener 20 comprises two basic components: 1) a molded, elongated elastic element 28 which has two ends and can be substantially stretched repeatedly without losing its general shape and strength; 2) an attachment connector 26 secured to one end of elongated elastic element 28.

In the preferred embodiment, elongated elastic element 28 (FIG. 1) is an elastomer with a high elongation limit and tensile strength, such as Ethylene Vinyl Acetate (EVA) or a Thermoplastic Rubber (TPR). However, elongated elastic element 28 can consist of any other substantially elastic material that can be repeatedly stretched, such as various other elastomeric polymers and copolymers, silicone rubber, nylon elastic, spandex, shock cord (“bungee cord”), etc. In the preferred embodiment, the length of elongated elastic element 28 is typically 12 cm. Elongated elastic element 28 has a diameter of roughly 5 mm. I presently prefer that elongated elastic element's 28 general shape is cord-like. However, it can be band-shaped, etc.

As shown in FIG. 1, elongated elastic element 28 is molded so as to form an annular ring-shaped first end 30 at the end opposite the end to which attachment connector 26 is attached. The diameter of annular ring-shaped first end 30 is approximately 20 mm. However, the diameter of annular ring-shaped first end 30 may be larger or smaller than 20 mm. The diameter of annular ring-shaped first end's 30 inner hole is roughly 15 mm, however the diameter may be larger or smaller than 15 mm.

As shown in FIGS. 1 and 2 the end of elongated elastic element 28 opposite to the end of elongated elastic element 28 molded so as to form annular ring-shaped first end 30, is molded so as to form a loop 24. In the preferred embodiment, this attachment ring loop 24 is substantially smaller than annular ring-shaped first end 30.

Attachment connector 26 may be comprised of any number of different parts. In the preferred embodiment, attachment connector 26 in FIGS. 1 and 2 comprises a lanyard hole attachment ring 26a. Preferably, lanyard hole attachment ring 26a is made of steel and is generally round. However, lanyard hole attachment ring 26a can consist of any other substantially rigid material such as plastic, leather, vinyl, polyethylene, polypropylene, etc. As shown in FIG. 2, in the preferred embodiment lanyard hole attachment ring 26a is a split key ring. However, lanyard hole attachment ring 26a may be a snap hook, spring hook, swivel hook, plastic bolt snap, ball chain, beaded lanyard, wire, string, leather strap, button strap, etc. Lanyard hole attachment ring 26a is attached to flashlight's butt portion 38 by looping lanyard hole attachment ring 26a through the flashlight's lanyard hole 34 as shown in FIG. 3. In the preferred construction, the diameter of lanyard hole attachment ring 26a is roughly 13 mm; however the diameter of lanyard hole attachment ring 26a may be larger or smaller than 13 mm. FIG. 2 shows lanyard hole attachment ring 26a fitted through attachment ring loop 24 thereby attaching lanyard hole attachment ring 26a to elongated elastic element 28. FIG. 3 shows lanyard hole attachment ring 26a looped through the flashlight's lanyard hole 34, thereby attaching flashlight fastener 20 to flashlight's butt portion 38.

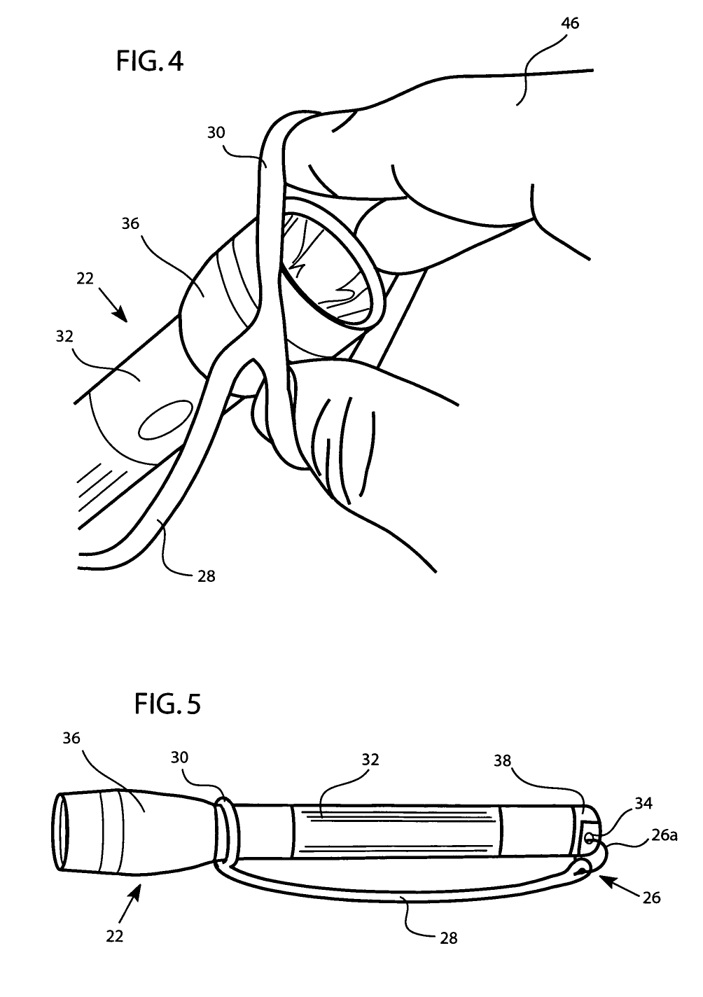

### OPERATION—FIGS. 4, 5, 6, 7, 8, 9, 10, 11, 12, 13, 14, 15, 16, 17, 18, 19, 20, 21

There are multiple ways to use flashlight fastener 20. The choice of which manner is employed will depend on the dimensions of the object to which flashlight 22 is being secured and the general direction the user desires the flashlight's beam of light to shine. However, all of these manners of operation require the user to secure annular ring-shaped first end 30 to flashlight 22. The manner in which to do this is relatively straightforward.

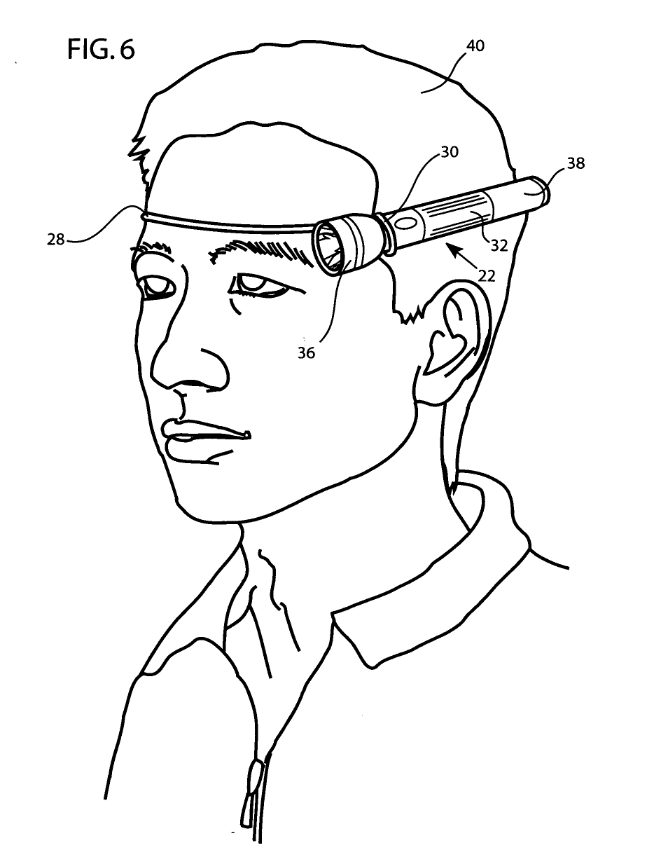

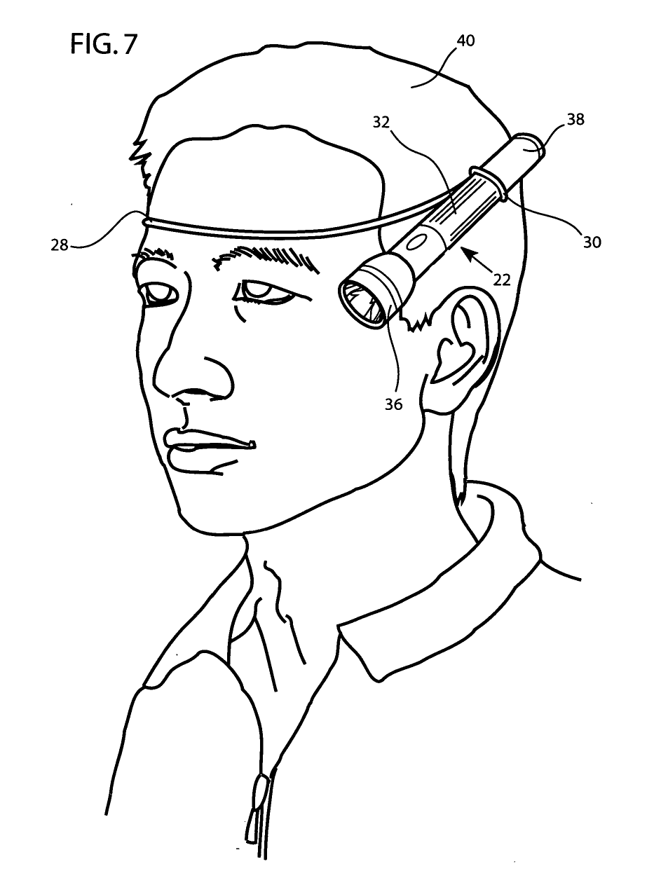

Namely, as shown in FIG. 4, one first grasps the flashlight's body portion 32 with one hand, and using the other hand (FIG. 4 shows a right hand 46 but the left hand can also be used), one grasps a portion of annular ring-shaped first end 30. Next, using the thumb and fingers of that hand, one stretches open annular ring-shaped first end 30 wider than the diameter of flashlight's head portion 36 as seen in FIG. 4. Next, one passes annular ring-shaped first end 30 downward over flashlight's head portion 36 and places annular ring-shaped first end 30 around flashlight's body portion 32 roughly immediately below flashlight's head portion 36. The smaller diameter of annular ring-shaped first end 30 relative to the larger diameter of flashlight's body portion 32 together with the elasticity of the now most likely stretched annular ring-shaped first end 30, will cause annular ring-shaped first end 30 to fit snugly around flashlight's body portion 32. Moreover, the larger diameter of the flashlight's head portion 36 relative to the diameter of annular ring-shaped first end 30 and flashlight's body portion 32, will secure annular ring-shaped first end 30 preventing it from sliding back over flashlight's head portion 36 and slipping off flashlight 22. As shown in FIG. 5, after annular ring-shaped first end 30 is placed about flashlight's body portion 32, flashlight fastener 20 forms a complete cincture of which flashlight 22 itself constitutes a portion.

To open the cincture, the user simply detaches annular ring-shaped first end 30 from flashlight 22. To unfasten annular ring-shaped first end 30 portion of flashlight fastener 20 from flashlight 22, the user simply grasps hold of annular ring-shaped first end 30 using the thumb and forefinger of one hand while gripping flashlight 22 with the other hand. Next, the user pulls annular ring-shaped first end 30 forward, thereby stretching annular ring-shaped first end 30 and thus enabling annular ring-shaped first end 30 to be pulled over flashlight's head portion 36 and off flashlight 22.

One such manner in which flashlight fastener 20 may be used is, holding flashlight's body portion 32 with one hand, one grasps the mid section of elongated elastic element 28 and stretches elongated elastic element 28 so as to stretch the cincture over one end of an object thereby retaining flashlight 22 snugly against the side of the object. In this fashion, flashlight 22 can be secured to various objects including different parts of the user's body such as, the side of the user's head 40 (FIG. 6) so as to direct the flashlight's beam of light in a forward direction.

Alternatively, flashlight 22 may be secured to the side of the head of the user's head 40 employing another method as shown in FIG. 6. Namely, the user first grasps flashlight's body portion 32 with his or her left hand, holding it in the desired position on the left side of the head 40 so flashlight's head portion 36 is directed in a forward manner. Next, using his or her right hand 46, the user reaches behind user's head 40 and grasps hold of annular ring-shaped first end 30. The user then stretches elongated elastic element 28 in the opposite direction of flashlight's butt portion 38 wrapping it across the back of the user's head 40 and around his her head 40 until reaching flashlight's head portion 36. The user then stretches annular ring-shaped first end 30 over flashlight's head portion 36, and places annular ring-shaped first end 30 about flashlight's body portion 32. Thus, flashlight 22 may also be securely fastened to the side of the head in this manner as shown in FIG. 6.

As shown in FIG. 7, if the user wishes to adjust the vertical angle at which the flashlight's beam of light is emitted, the user can simply hold flashlight 22 with one hand, and using the other hand, grip annular ring-shaped first end 30 between the thumb and forefinger. Next, pull annular ring-shaped first end 30 towards flashlight's butt portion 38. Therefore, as annular ring-shaped first end 30 is dragged towards flashlight's butt portion 38 the weight of flashlight's head portion 36 and flashlight's body portion 32 will pull flashlight's head portion 36 downward thereby altering the vertical angle at which the flashlight's beam of light is emitted. If the user desires to adjust the vertical angle at which the beam of light is emitted downward, the user need only pull annular ring-shaped first end 30 towards flashlight's butt portion 38 until the desired angle is achieved.

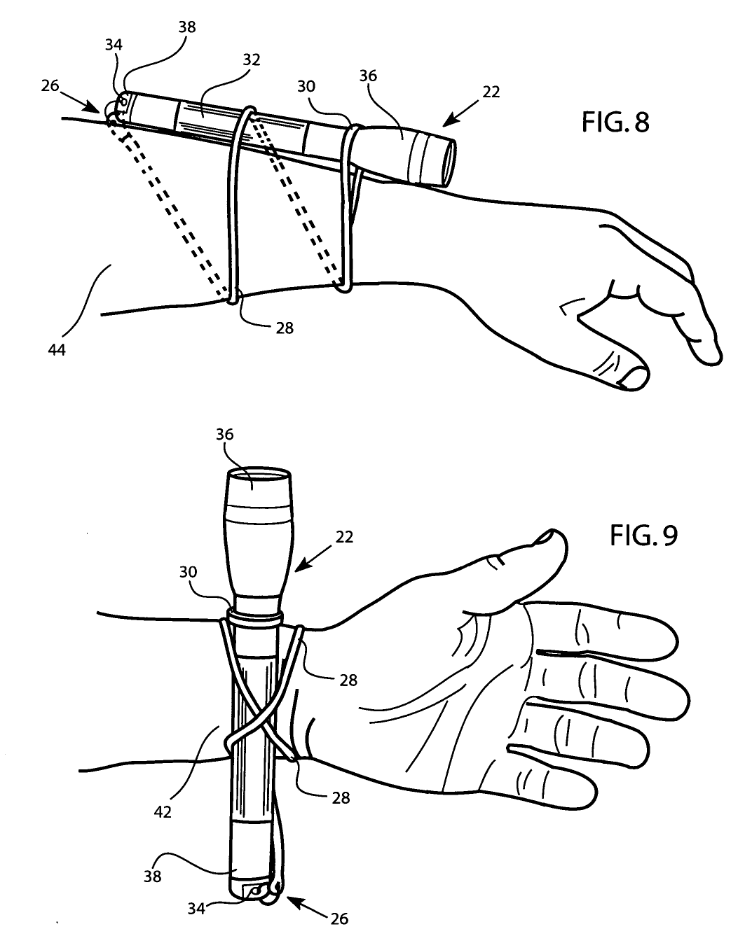

Flashlight 22 may also be fastened to an object in a variety of other ways, such as in a multiple wrapping fashion. For example, as shown in FIG. 8, flashlight 22 is secured to the top of the outer left forearm 44. The manner in which flashlight 22 (FIG. 8) may be secured in this fashion is relatively straightforward. Namely, one first lays the arm in a prone position with the palm of the hand facing downward. Next, lay flashlight 22 on the top of the outer left forearm 44 in the desired position so flashlight's head portion 36 is directed in a forward manner towards the hand. To steady flashlight 22, the user may press his or her chin against flashlight 22. Next, grasping annular ring-shaped first end 30 with the right hand 46, the user wraps elongated elastic element 28 downward and around the entire circumference of left forearm 44, in the process, drawing elongated elastic element 28 across flashlight's body portion 32. As shown in FIG. 8, this action is repeated more than once, wrapping elongated elastic element 28 around the entire circumference of left forearm 44, in the process, drawing elongated elastic element 28 across flashlight's body portion 32 towards flashlight's head portion 36. The user then stretches annular ring-shaped first end 30 over flashlight's head portion 36, and places annular ring-shaped first end 30 about flashlight's body portion 32. Thus, this will result in flashlight 22 being secured snuggly to the outer left forearm 44 as shown in FIG. 8.

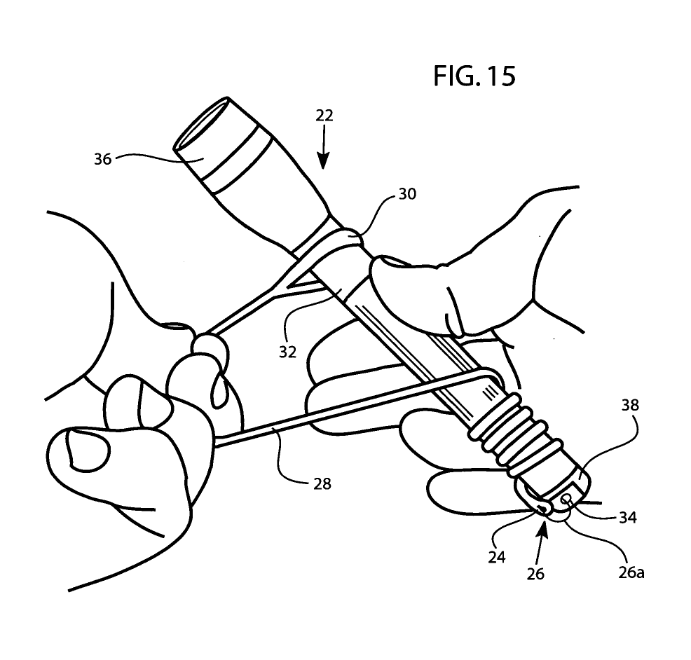

Alternatively, the user may employ another manner to secure flashlight 22 in the fashion shown in FIG. 8. Namely, grasping elongated elastic element 28 with the right hand 46 while holding flashlight 22 with the left hand, the user first wraps elongated elastic element 28 around flashlight's body portion 32 multiple times. Next, the user stretches annular ring-shaped first end 30 over flashlight's head portion 36, and places annular ring-shaped first end 30 about flashlight's body portion 32 (as shown in FIG. 15). Next, grasping several passes of elongated elastic element 28 wound around flashlight's body portion 32 with right hand 46, the user stretches multiple passes of elongated elastic element 28 away from flashlight's body portion 32 and simply slides his or her left hand between elongated elastic element 28 and flashlight's body portion 32, pulling flashlight 22 in the direction of the left elbow, until flashlight 22 is secured into the desired position on the outer left forearm 44 as shown in FIG. 8.

Similarly, both of the above methods to secure flashlight 22 to the outer left forearm 44 can be used to secure flashlight 22 to the inner left forearm 44, and likewise to other similarly shaped objects. However, it should be understood that flashlight 22 can be secured to an object in still other ways.

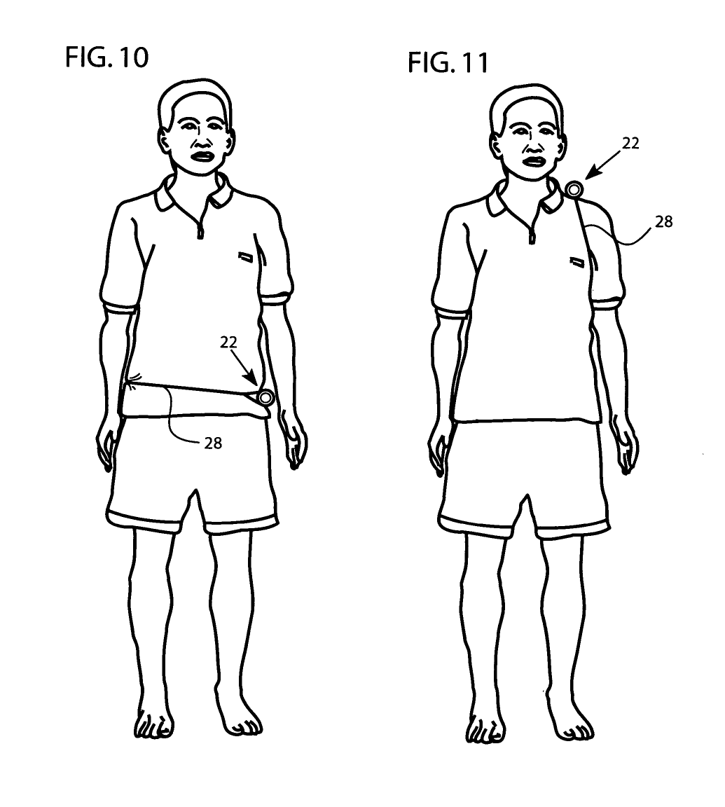

Flashlight 22 may also be fastened to an object in a crisscross binding fashion. For example, as shown in FIG. 9, flashlight 22 is secured at a generally 90 degree angle to the plane of the user's left forearm 44 on the inner left wrist 42 of the user in such a fashion. To secure flashlight 22 in this fashion, the user first lays his or her left hand, palm up, in a prone position. Next, the user lays flashlight 22 across the inner left wrist 42 of the left hand, and grasping annular ring-shaped first end 30 with his or her right hand 46, the user draws elongated elastic element 28 beneath the outer left wrist 42 and upwards, around the upper left side of flashlight 22. Continuing, the user then draws elongated elastic element 28 downwards diagonally across flashlight's body 32 towards the lower right side of flashlight 22 and downwards beneath outer left wrist 42, wrapping elongated elastic element 28 beneath the outer left wrist 42 towards the upper right side of flashlight 22. Continuing the user draws elongated elastic element 28 upwards and around the upper right side of flashlight 22 and draws elongated elastic element 28 downwards diagonally across the flashlight's body portion 32 towards the lower left side of flashlight 22 and downwards beneath the outer left wrist 42 then upwards wrapping elongated elastic element 28 beneath the outer left wrist 42 towards flashlight's head portion 36. The user then stretches annular ring-shaped first end 30 over flashlight's head portion 36, and places annular ring-shaped first end 30 about flashlight's body portion 32. Flashlight 22 may therefore in this way be secured firmly to the inner left wrist 42 of the user as shown in FIG. 9, preventing flashlight 22 turning substantially to either side. Similarly, flashlight 22 may be secured in this manner to other similarly shaped objects.

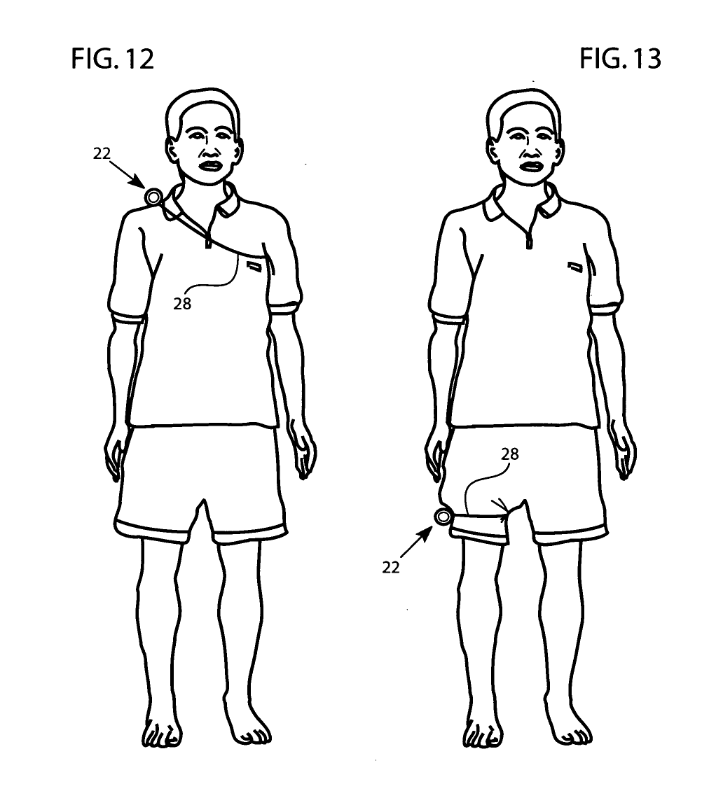

Flashlight 22 may also be secured to the user's waist. FIG. 10 shows flashlight 22 secured in a horizontal manner just above the left hip of a user standing in an upright position. To fasten flashlight 22 in this manner, the user first grasps flashlight's body portion 32 with his or her left hand, placing it in the desired position above the hip so flashlight's head portion 36 is directed in a forward manner while maintaining his or her grip on flashlight's body portion 32. Next, the user reaches behind his or her back with the right hand 46 and grasps hold of annular ring-shaped first end 30. Next, the user stretches elongated elastic element 28 across his or her back and around his or her waist across the front of his or her body towards flashlight's head portion 36. The user then stretches annular ring-shaped first end 30 over flashlight's head portion 36, and places annular ring-shaped first end 30 about flashlight's body portion 32. Thus, flashlight 22 may be securely fastened above the hip of the user as shown in FIG. 10 in this manner.

Flashlight 22 may also be secured to the user's shoulder. As shown in FIG. 11, flashlight 22 is secured in a horizontal manner on the top of the left shoulder of a user standing in an upright position. To fasten flashlight 22 in the manner shown in FIG. 11, the user, grasping flashlight's body portion 32 with his or her left hand, places flashlight 22 onto the desired position on the top of his or her left shoulder so flashlight's head portion 36 is directed in a forward manner while maintaining his or her grip on flashlight's body portion 32. Next, using his or her right hand 46, the user reaches beneath his or her left armpit towards the rear portion of the left shoulder. Next, using his or her right hand 46, the user grasps hold of annular ring-shaped first end 30 and draws elongated elastic element 28 under the left armpit towards the front portion of the user's shoulder. The user then stretches annular ring-shaped first end 30 upwards and over flashlight's head portion 36, and places annular ring-shaped first end 30 about flashlight's body portion 32. Flashlight 22 may be securely fastened to the top of the user's left shoulder in this manner. The user may adjust the vertical angle at which the flashlight's beam of light is emitted downward by simply grasping hold of flashlight 22 with his or her right hand 46, and dragging flashlight 22 forward until the light is directed at the desired angle.

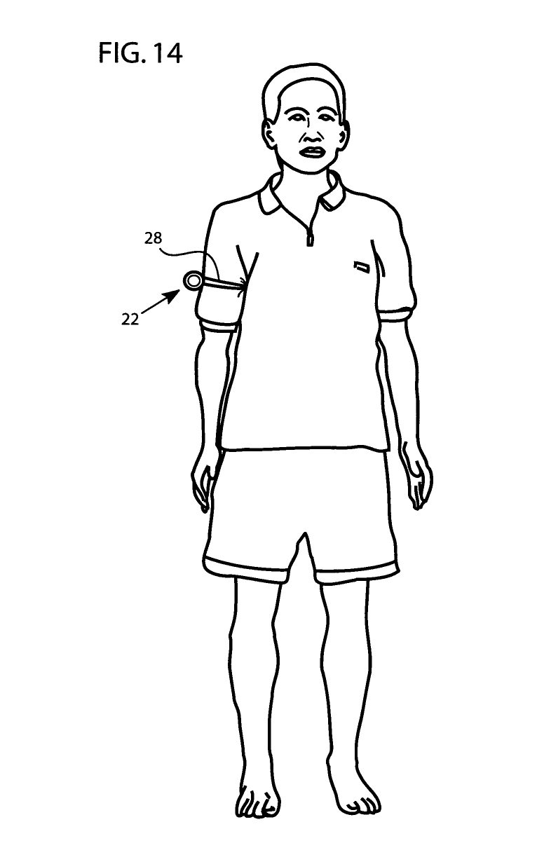

FIG. 12 shows flashlight 22 secured in a horizontal manner on the top of the right shoulder of a user standing in an upright position. To fasten flashlight 22 in the manner shown in FIG. 12, the user, grasping flashlight's head portion 36 with his or her right hand 46, reaches over his or her right shoulder and holds flashlight 22 behind his or her back allowing elongated elastic element 28 to hang downwards. Next, the user, using his or her left hand, reaches behind his or her back towards flashlight 22 and grasps hold of annular ring-shaped first end 30. Next, the user, using his or her right hand 46, pulls flashlight 22 upwards to a resting position on the top of the right shoulder. Next, the user, using his or her left hand, stretches elongated elastic element 28 stretching elongated elastic element 28 across his or her back and under his or her left armpit, stretching elongated elastic element 28 across the front of his or her chest. The user then stretches annular ring-shaped first end 30 over flashlight's head portion 36 and places annular ring-shaped first end 30 about flashlight's body portion 32. Flashlight 22 may be securely fastened to the top of the user's right shoulder in this manner. The user may adjust the vertical angle at which the flashlight's beam of light is emitted downward by simply grasping hold of flashlight 22 with his or her right hand 46, and dragging flashlight 22 forward until the light is directed at the desired angle.

Flashlight 22 may also be secured to the user's right upper leg. As shown in FIG. 13, flashlight 22 is secured in a horizontal manner on the outer side of a user's upper right leg in which the user is shown in a standing position. To fasten flashlight 22 in the manner shown in FIG. 13, the user first grasps flashlight's body portion 32 using his or her right hand 46 and places it into the desired position on the side of the upper leg so flashlight's head portion 36 is directed in a forward manner while the user maintains his or her grip on flashlight's body portion 32. Next, using his or her left hand, the user reaches between his or her legs from the front of the body, passing the hand behind the upper right leg towards flashlight's butt portion 38, grasping annular ring-shaped first end 30. Next, using his or her left hand, the user draws elongated elastic element 28 across the rear of the upper leg towards the inner side of the upper leg, stretching it around the upper leg across the front of the leg until it reaches flashlight's head portion 36. The user then stretches annular ring-shaped first end 30 over flashlight's head portion 36, and places annular ring-shaped first end 30 about flashlight's body portion 32. Thus, flashlight 22 may be securely fastened to the outer side of the user's upper left leg in this manner as shown in FIG. 13.

Flashlight 22 may also be secured to the user's arm. FIG. 14 shows flashlight 22 fastened in a horizontal manner on the outer side of a user's right upper arm in which the user is shown in a standing position. There are a variety of ways to fasten flashlight 22 in the manner shown in FIG. 14.

For example, the user can first grasp flashlight's body portion 32 with one hand, and using the other hand grasp a portion of annular ring-shaped first end 30. Next, using the thumb and fingers of that hand, the user stretches open annular ring-shaped first end 30 wider than the diameter of flashlight's head portion 36 as seen in FIG. 4. To steady the flashlight, the user may press his or her chin against flashlight 22. Next, the user passes annular ring-shaped first end 30 downward over flashlight's head portion 36 and places annular ring-shaped first end 30 around flashlight's body portion 32 roughly immediately below flashlight's head portion 36. Thus, a complete cincture will be formed of which flashlight 22 itself forms a portion. Next, holding flashlight's body portion 32 with the left hand, the user inserts his or her right hand 46 through the cincture, passing the cincture upwards over the arm until flashlight 22 is positioned on the desired part of the arm.

Alternatively, the user may secure flashlight 22 (FIG. 14) to the outer side of his or her right arm employing another method. Namely, the user first grasps flashlight's body portion 32 with his or her left hand, holding it in the desired position on the arm so flashlight's head portion 36 is directed in a forward manner. Next, using the left hand, the user reaches across the front of his or her chest and behind the right arm, grasping hold of annular ring-shaped first end 30. Next, the user stretches elongated elastic element 28 from behind the arm towards the torso and around across the front of his or her arm towards flashlight's head portion 36. The user then stretches annular ring-shaped first end 30 over flashlight's head portion 36, and places annular ring-shaped first end 30 about flashlight's body portion 32. Thus, Flashlight 22 may be securely fastened to the outer side of the arm in this manner as shown in FIG. 14.

If the cincture is not small enough to allow flashlight 22 to be fastened snuggly to an object, there is another manner in which elongated elastic element 28 actively used to form a portion of the cincture may be shortened. Namely, the user first wraps elongated elastic element 28 around the object multiple times and then stretches annular ring-shaped first end 30 over flashlight's head portion 36, placing annular ring-shaped first end 30 about flashlight's body portion 32. In this fashion, the cincture will be tightened and allow flashlight 22 to be fastened snuggly to the object.

If the diameter of the portion of the object to which the user desires to secure flashlight 22 is not wide enough so as to allow flashlight 22 to be fastened snuggly, there is still yet another manner in which the flashlight may be fastened as shown in FIG. 15. Namely, the user first wraps elongated elastic element 28 around flashlight's body portion 32 (FIG. 15) more than one time before attaching annular ring-shaped first end 30 to flashlight's head portion 36, so as to shorten the length of elongated elastic element 28 actively used to form a portion of the cincture. As shown in FIG. 15, elongated elastic element 28 may be adjusted in this manner to form a generally tighter cincture. Thus, flashlight 22 may then be secured in a generally more snug fashion around the object.

It should be understood that, beyond the above stated methods for securing flashlight 22 to an object, there are numerous other ways to secure flashlight 22 to an object using flashlight fastener 20. What method the user chooses to employ will depend largely on the specific object to which the user wishes to secure the flashlight.

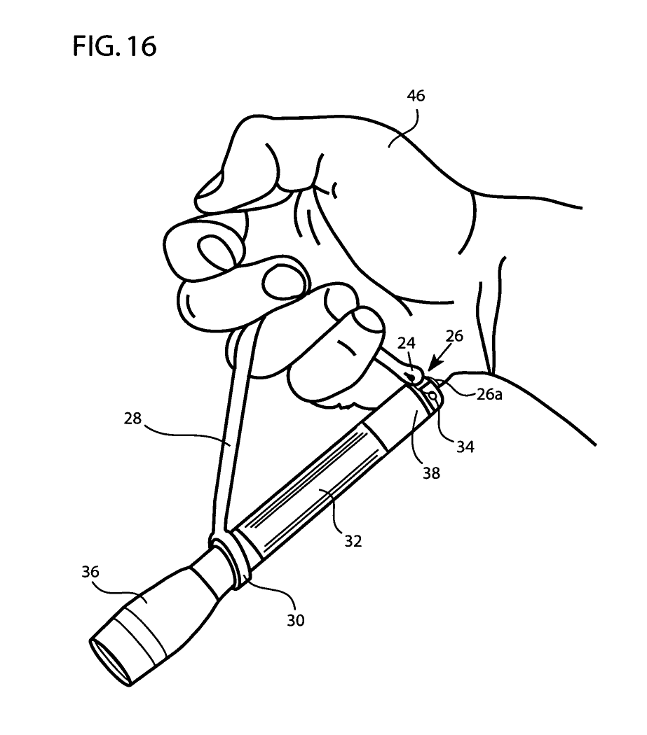

As shown in FIG. 16, when annular ring-shaped first end 30 is placed about flashlight's body portion 32 generally immediately below flashlight's head portion 36, flashlight fastener 20 can be used as a handle allowing the user to conveniently hold flashlight 22 with one or two fingers (FIG. 16 shows a right hand 46).

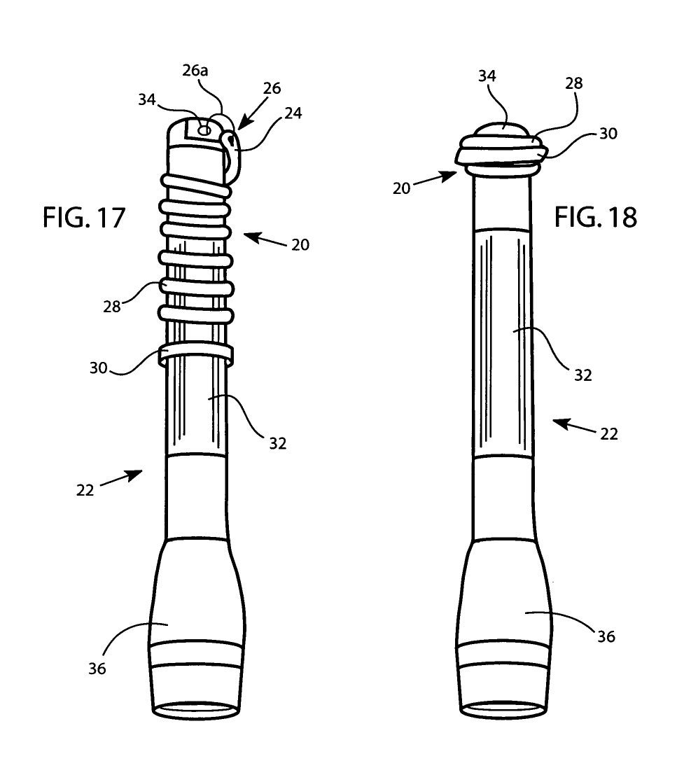

FIG. 17 shows elongated elastic element 28 wrapped repeatedly around flashlight's body portion 32 serving two functions: 1) elongated elastic element 28 can be stored in a non-cumbersome fashion on flashlight's body portion 32; 2) elongated elastic element 28 when wrapped in this manner will serve as a grip for the user's hand when holding flashlight's body portion 32.

Alternatively, flashlight fastener 20 may be stored on flashlight's body portion 32 in yet another way. As shown in FIG. 18, the user can wrap elongated elastic element 28 multiple times around flashlight's butt portion 38 so that elongated elastic element 28 is coiled upon itself in an overlying manner and unobtrusive fashion.

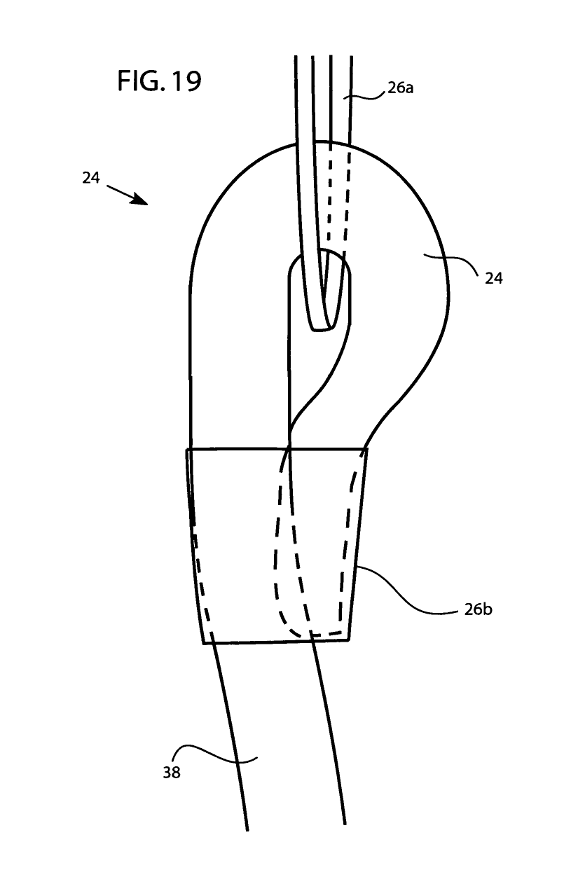

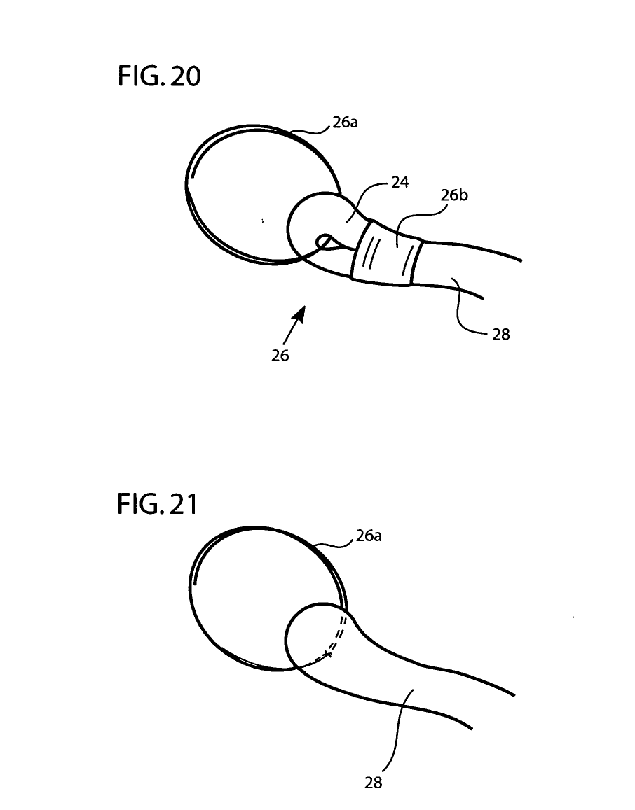

### FIGS. 19, 20—ALTERNATIVE EMBODIMENTS

There are various possibilities with regard to the structure of attachment connector 26. Attachment connector 26 may be comprised of any number of different parts. For example, as shown in FIGS. 19 and 20 attachment connector 26 comprises two components: 1) lanyard hole attachment ring 26a; 2) a clamp 26b. In FIGS. 19 and 20, elongated elastic element 28 is looped through lanyard hole attachment ring 26a and folded back in overlying relation to itself. Clamp 26b in FIGS. 19 and 20 is secured tightly around the entire portion of elongated elastic element 28 that is folded back upon itself, consisting of two adjacent segments of elongated elastic element 28, thereby forming a loop 24 at the end of elongated elastic element 28 that completely encircles lanyard hole attachment ring 26a. Clamp 26b is tight enough to prevent slippage of elongated elastic element 28. Preferably, clamp 26b is a metallic band. However, clamp 26b can consist of any other material that can securely bind together the two adjacent portions of elongated elastic element 28 that is folded back upon itself, such as a band of rigid plastic, rubber, cloth, industrial-strength tape, plastic mono-filament line (“fishing line”), wire etc. The clamp 26b may be a cord coupler as is commonly used on lanyards. Alternatively, it is also contemplated in the present invention that the portion of elongated elastic element 28 that is folded back upon itself may be adjacently secured by means other than a clasp, such as substantially strong epoxy, stitching, stapling etc. In this manner, attachment connector 26 can be securely attached to the one end of elongated elastic element 28 as shown in FIGS. 19 and 20.

Alternatively, as shown in FIG. 21, elongated elastic element 28 may be manufactured so as to embed a portion of lanyard hole attachment ring 26a inside a portion of the end of elongated elastic element 28 opposite the end of elongated elastic element 28 comprising annular ring-shaped first end 30. This will allow the device's design to be further simplified. Thus the device can be manufactured relatively cheaply and with smaller chance of breakage.

### ADVANTAGES

From the description above, a number of advantages of my flashlight fastener become evident:

(a) Thus, since the flashlight fastener is substantially elastic enabling it to be stretched, the flashlight fastener can be use to fasten a flashlight to a wide range of objects of significantly different shapes and sizes including many different parts of the human body, thereby allowing a person to use a flashlight while maintaining free use of his or her hands. Thus the flashlight fastener is not limited to use with a specific object, such as, the wrist, the head, the barrel of a rifle, etc. Rather, the flashlight fastener can accommodate and be used with a great number of objects. The flashlight fastener's elasticity and cord-like structure enables a flashlight to be secured to an object in various manners and therefore the user may choose the most appropriate method with which to fasten the flashlight to an object. Thus, the flashlight fastener has a universal character in terms of its use and potential application.

(b) As the flashlight fastener is designed to be attached to the lanyard hole of a flashlight, the device may be kept attached to the flashlight at all times, allowing the device to be readily available for use. Thus, the user need not anticipate the need to use the device in advance.

(c) As the flashlight fastener enables the user to secure the flashlight to a wide range of objects, the flashlight may be secured to an overhanging object and therefore be used as an overhead light source.

(d) As the device attaches to a flashlight's lanyard hole, the device may be used in conjunction with a wide range of flashlights designs. Thus, the device may be sold separately as a flashlight accessory.

(e) The attachment connector's ring allows the device to be attached and detached from the flashlight in a simple manner. Further, because the device may be wrapped around the flashlight, the device may be stored conveniently in a non-cumbersome manner.

(f) The device's elasticity enables it to conform to the general shape of an object thus not requiring the user to further adjust the device so as to make it accommodate the specific dimensions of the object.

(g) As the device, in the preferred embodiment, only comprises two separate pieces, the device is relatively simple in design and cheap to manufacture.

### CONCLUSION, RAMIFICATIONS, AND SCOPE

Accordingly, the reader will see that the flashlight fastener of this invention provides an economical device to conveniently and swiftly secure a flashlight to a wide range of objects of significantly different shapes and sizes including many different parts of the human body, thereby allowing a person to use the flashlight while maintaining free use of his or her hands.

Other advantages are: using this device a conventional flashlight may be readily converted into a headlamp-type light; if the flashlight is fastened around the user's head the vertical orientation at which the beam of light is directed may be adjusted to a plurality of angles if desired; the device will allow most flashlights to be fastened to a bicycle so as to be used as a cycle light; the device may serve as a conventional flashlight lanyard strap; the device can be attached to a flashlight together with a conventional lanyard; the device may also serve as a hand strap; the device can serve as a handle for the flashlight; the device can be removed from the flashlight and used separately as an elastic binding cord; the device may be stored by being wound around the body of the flashlight simultaneously serving as a retention grip for the user's hand. Furthermore, the device has the additional advantages in that

its design often allows it to be used in several unique ways allowing the user to choose the most appropriate method;

it may be conveniently stored on the flashlight so as to be readily available when the need to use the device arises;

it allows a flashlight to be used as an overhead light source;

it may be used in conjunction with a wide range of flashlight designs, and sold separately as a relatively cheap flashlight accessory;

it may be easily removed from and reattached to the flashlight;

it may be wrapped around the flashlight and thus stored conveniently in this non-cumbersome manner;

it can conform easily to objects of various dimensions, and thus does not require the user to make further adjustments;

its design is simple and may be manufactured relatively cheaply.

While the above description contains many specificities, these should not be construed as limitations on the scope of the invention, but as exemplifications of the presently preferred embodiments thereof. Many other ramifications and variations are possible within the teachings of the invention. For example, the attachment connector may comprise a releasable key ring, a snap hook, a spring hook, a swivel hook, a plastic bolt snap, a bead chain, a ball chain, etc; the elongated elastic element may be made larger or smaller, shorter or longer; the elongated elastic element may be of various colors; the elongated elastic element may be various materials such as, nylon, shock cord (“bungee cord”), other elastomeric polymers and copolymers, etc; the elongated elastic element may be made of a phosphorescent material; the elongated elastic element may be band-shaped; the length of elongated elastic element may be designed to be adjustable; one end of the device may be permanently fixed to the flashlight; the elongated elastic element may be made of an elastic material that is substantially smooth; the elongated elastic element may be covered in a smooth material, etc.

Thus the scope of the invention should be determined by the appended claims and their legal equivalents, and not by the examples given.

I claim:

1. A device for fastening a flashlight of the type having a lanyard hole, to objects of varying shapes and sizes including but not restricted to different parts of a human body, comprising:
(a) an elongated substantially elastic element having two ends with a generally annular ring-shaped first end, wherein the elastic element's generally annular ring-shaped first end may be stretched over said flashlight's head portion and placed about said flashlight's body portion, and
(b) an attachment connector attached to said elongated substantially elastic element's second end, said attachment connector adapted to be attached to said lanyard hole thereby attaching said device to said flashlight,
whereby when said attachment connector is attached to said lanyard hole, said generally annular ring-shaped first end is stretched over said flashlight's head portion placing said generally annular ring-shaped first end about said flashlight's body portion securing said generally annular ring-shaped first end to said flashlight, said device will form a cincture of which said flashlight itself forms a portion providing a means to fasten said flashlight to said objects of varying shapes and sizes including different parts of said human body.

2. The device of claim 1 wherein said elongated substantially elastic element is an elastomeric polymer.

3. The device of claim 1 wherein said elongated substantially elastic element's second end comprises a loop.

4. The device of claim 1 wherein a portion of said attachment connector is embedded inside a portion of said elongated substantially elastic element's second end.

5. The device of claim 1 wherein said attachment connector comprises more than one component.

6. The device of claim 1 wherein said elongated substantially elastic element is an elastomeric cord.

7. The device of claim 1 wherein said elongated substantially elastic element is an elastomeric band.

8. The device of claim 1 wherein the length of said elongated substantially elastic element forming the cincture is adapted to be adjustable.

9. The device of claim 1 wherein said elongated substantially elastic element is at least partially a phosphorescent material.

10. The device of claim 1 wherein said elongated substantially elastic element's exterior surface is a specific design.

11. The device of claim 1 wherein said elongated substantially elastic element is a specific color.

12. The device of claim 1 wherein said flashlight fastener's components are manufactured in various sizes.

13. The device of claim 1 wherein only a portion of said elongated substantially elastic element is an elastic material.

14. The device of claim 1 wherein said attachment connector comprises an incomplete annulus wherein said annulus's two distal ends overlap in an overlying relation to itself whereby said incomplete annulus may be secured to said lanyard hole.

15. A flashlight fastening device comprising an elongated substantially elastic element having first and second ends, wherein said elongated substantially elastic element has a generally loop-shaped first end, and said elongated substantially elastic element's second end is secured to the body portion of a flashlight, whereby a user can stretch said elongated substantially elastic element around an object, secure said elongated substantially elastic element's generally loop-shaped first end to said flashlight so as to encircle a portion of said flashlight thereby enabling said flashlight to be fastened securely to said object.

16. The flashlight fastening device of claim 15 wherein said elongated substantially elastic element's second end is permanently attached to said flashlight.

17. The flashlight fastening device of claim 15 wherein said elongated substantially elastic element's second end comprises a loop, wherein said loop is attached to an attachment connector, wherein said attachment connector is adapted to be secured to a lanyard hole of a flashlight.

18. A method for fastening a flashlight to objects of various shapes and sizes including different parts of a human body, comprising the steps of:
(a) securing an attachment connector to said flashlight's lanyard hole, wherein said attachment connector is attached to the second end of an elongated substantially elastic element, wherein said elongated substantially elastic element's first end comprises a generally loop-shaped attachment member;
(b) grasping said flashlight with one hand and grasping said elongated substantially elastic element's first end comprising said generally loop-shaped attachment member with the other hand;
(c) stretching said elongated substantially elastic element's first end comprising said generally loop-shaped attachment member over the head portion of said flashlight and placing it about the body portion of said flashlight thereby forming an endless circular annulus of which said flashlight itself forms a portion;
(d) grasping said flashlight with one hand and grasping said elongated substantially elastic element with said other hand;
(e) stretching said elongated substantially elastic element so as to enable placement of said endless circular annulus over one end of said object and placement of said endless circular annulus around said object so as to encircle said object thereby retaining said flashlight snugly against the surface of said object.

19. The method as defined in claim 18 wherein said elongated substantially elastic element's second end is loop-shaped.

20. The device of claim 18 wherein a portion of said attachment connector is embedded inside a portion of said elongated substantially elastic element's second end.
